(19) United States
(12) Patent Application Publication
(10) Pub. No.: US 2024/0218538 A1
(43) Pub. Date: Jul. 4, 2024

(54) HIGH SURFACE AREA, HIGH POROSITY IRIDIUM-BASED CATALYST AND METHOD OF MAKING

(71) Applicant: UOP LLC, Des Plaines, IL (US)

(72) Inventors: Zhanyong Li, Schaumburg, IL (US); Chunqing Liu, Arlington Heights, IL (US); Stacey Deptuch, Hickory Hills, IL (US); Dennis F. van der Vliet, Skokie, IL (US)

(21) Appl. No.: 18/457,882

(22) Filed: Aug. 29, 2023

Related U.S. Application Data
(60) Provisional application No. 63/477,422, filed on Dec. 28, 2022.

(51) Int. Cl. C25B 11/081; C25B 1/04

(52) U.S. Cl. CPC C25B 11/081; C25B 1/04

(57) ABSTRACT

An iridium-based catalyst and method of making the catalyst are described. The catalyst comprises a catalytic material comprising particles comprising iridium or a mixture of iridium and iridium oxide. The particles comprise an interconnected network of nanoparticles. The particles are in the range of 50 nm to 1 μm, and the nanoparticles are in the range of 2 nm to 15 nm. It may have a BET surface area of 30 m²/g or more and a pore volume of at least 0.10 cc/g. The catalyst is made using organic structure directing agents.

### RELATED APPLICATIONS

This application claims priority to U.S. Provisional Patent Application Ser. No. 63/477,422 filed on Dec. 28, 2022, the entirety of which is incorporated herein by reference.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting of water into hydrogen and oxygen; the reaction is given by Eq. 1 below. The water electrolysis process is an endothermic process and electricity is the energy source. Water electrolysis has zero carbon footprint when the process is operated by renewable power sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115 such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e⁻), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

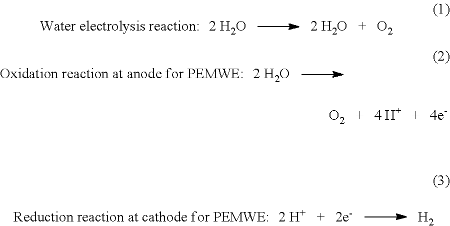

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

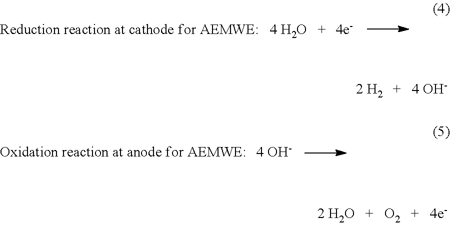

IrO₂ is widely accepted as the most efficient oxygen evolution reaction (OER) catalyst in PEM-WE due to its high activity and stability. However, its limited supply and high price limits its use.

Therefore, there is a need for a high activity IrO₂ which can be used at a lower loading while providing comparable or improved performance compared to commercial IrOₓ catalysts.

### BRIEF DESCRIPTION OF THE DRAWINGS

FIG. 1 is an illustration of a PEMWE system.

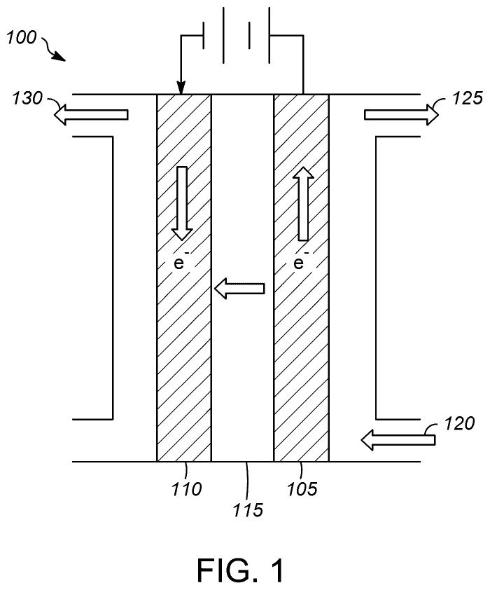

FIG. 2 is an illustration of an AEMWE system.

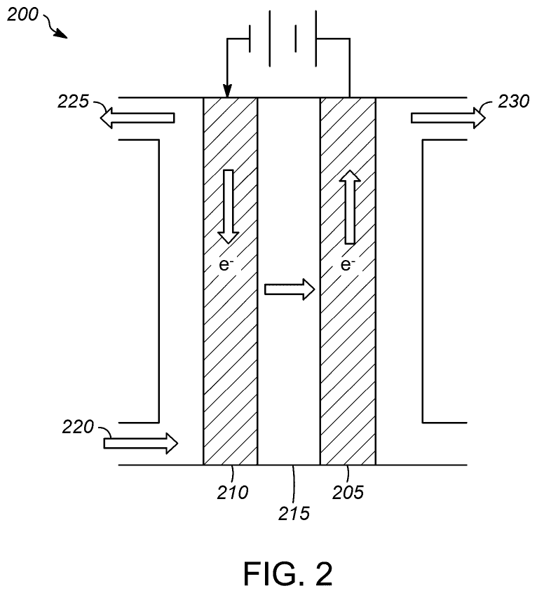

FIG. 3A, B, C are the scanning transmission electron microscopy (STEM) images of the Ir-oleylamine catalyst at different length scale.

FIG. 4 is the graph showing the comparison of OER activity of (a) as synthesized Ir-oleylamine according to the present invention; and (b) oxidized Ir-oleylamine according to the present invention and (c) a commercial IrO₂ catalyst.

FIG. 5 is a graph showing the polarization curves of a water electrolysis cell comprising of (a) Ir-oleylamine made according to the present invention and (b) a commercial IrO₂ catalyst.

### DESCRIPTION

A high loading of about 2 mg/cm² IrOₓ OER catalyst in the anode layer of the catalyst-coated membrane (CCM) for PEMWE is required for the current state-of-art PEM water electrolyzer to maintain high performance and high stability. Reducing the IrOₓ OER catalyst loading to 0.5 mg/cm² or less results in low durability and low electrolyzer efficiency due to poor mechanical stability of the very thin IrOₓ-based anode catalyst layer and defects in the CCM. The current state-of-the-art commercial IrOₓ catalyst utilizing spherical IrOₓ nanoparticles has less contact among the adjacent particles and therefore forms defects easily in the very thin anode coating layer on the PEM. The low loading of IrOₓ OER catalyst in the anode layer of the CCM leads to a defective coating layer and poor electrical contact between the catalyst coating layer and the porous transport layer (PTL). Therefore, the low-loading catalyst coating layer with defects causes high cell/stack voltage resulting in low electrolyzer efficiency. The BET surface area of several commercial IrOₓ catalysts was measured, and all of the catalysts had BET surface areas below 25 m²/g. The pore volume of those commercial IrOₓ catalysts was also measured, and the pore volume was 0.05 cc/g or less.

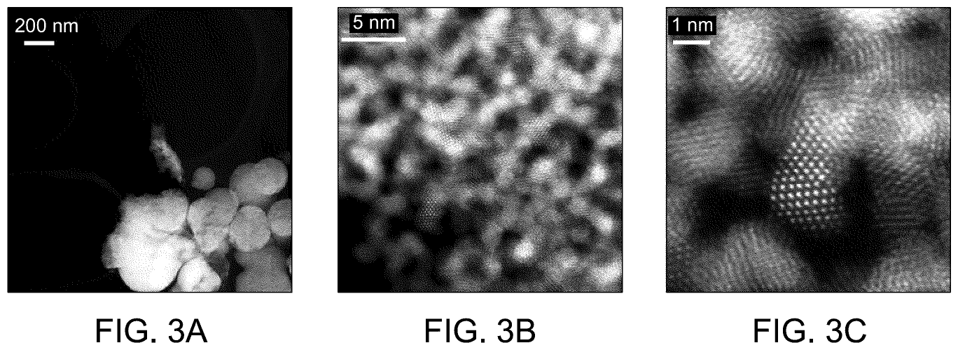

The current invention provides a solution to reduce IrOₓ loading significantly without the loss of performance and durability. A family of new Ir/IrO₂ catalysts for oxygen evolution reaction (OER) in a PEMWE or AEMWE has been developed. The highly active iridium-based materials have high porosity and high surface area. The catalyst comprises particles comprising iridium or a mixture of iridium and iridium oxide in the range of 50 nm to 1 μm (FIG. 3A). The particles comprise an interconnected network of nanoparticles, in which one nanoparticle is connected with one or more adjacent nanoparticles forming a network of Ir particles (FIG. 3B). Each nanoparticle is in the range of 2 nm to 15 nm in size (FIG. 3C). A CCM made using the high surface area, high porosity, high activity Ir/IrO₂ as the OER catalyst had comparable performance to a commercial IrO₂ catalyst at a lower IrO₂ loading.

The morphology of the IrO₂ is important, particularly when the IrOₓ loading in the anode catalyst layer is low (e.g., 0.5 mg/cm² or less). Commercial IrO₂ have a spherical morphology, which introduces too many defects into the catalyst layer to maintain the activity when the IrO₂ loading is lowered. The defects in the thin IrO₂ catalyst coating layer are normally the areas without the catalyst coating due to less overlap among the adjacent particles. In contrast, the morphology of the particles comprising the interconnected network of nanoparticles maintains the continuous, well-connected catalyst layer structure in the thin catalyst coating layer, resulting in low resistance and good performance. The Ir/IrOₓ with the desired morphology of particles comprising the interconnected network of nanoparticles has a higher tendency to form a continuous anode catalyst layer without pinholes in the CCM. The structure of the interconnected network of nanoparticles provides better contact of the Ir/IrOₓ particles with each other in the anode catalyst layer, leading to a lower resistance. A uniform anode catalyst layer also helps to maintain its low contact resistance with the porous transport layer.

The PEM electrolyzer testing results (discussed below) showed that a CCM with about 0.2 mg/cm² IrO₂ loading of the present catalyst exhibited comparable performance to a commercial IrO₂ with about 1.0 mg/cm² loading under the same testing conditions.

The catalyst particles are in the range of 50 nm to 1 μm, or 50 nm to 500 nm, or 100 nm to 500 nm, or 200 nm to 500 nm. The nanoparticles are in the range of 2 nm to 15 nm, or 2 nm to 10 nm, or 2 nm to 5 nm.

The catalyst has a pore volume of 0.10 cc/g or more, or 0.20 cc/g or more, or 0.30 cc/g pr more, or in a range of 0.10 cc/g to 0.70 cc/g, in a range of 0.10 cc/g to 0.60 cc/g, or in a range of 0.10 cc/g to 0.50 cc/g, or in a range of 0.10 cc/g to 0.40 cc/g.

The catalyst has a BET surface area of 30 m²/g or more, or 50 m²/g or more, or in a range of 30 m²/g to 800 m²/g, or 50 m²/g to 700 m²/g, or 50 m²/g to 600 m²/g, or 50 m²/g to 500 m²/g, or 50 m²/g to 400 m²/g, or 50 m²/g to 300 m²/g.

In one embodiment, the catalyst has a BET surface area in a range of 30 m²/g to 300 m²/g and a pore volume is in a range of 0.10 cc/g to 0.70 cc/g.

In one embodiment, the particles have a size in the range of 50 nm to 500 nm, the nanoparticles have a size in the range of 2 nm to 5 nm, and the pore volume is in the range of 0.10 cc/g to 0.40 cc/g.

In one embodiment, the particles have a size in a range of 200 nm to 500 nm, the nanoparticles have a size in the range of 2 nm to 5 nm, and the pore volume is in a range of 0.10 cc/g to 0.40 cc/g.

The catalyst is made using an organic structure directing agent. The organic structure directing agent coordinates to the Ir precursor, forming a coordination complex. The presence of the coordinating ligands affects the packing of the Ir species of the material in the solution because of the steric of the organic structure directing agent. Upon the addition of a reducing agent, Ir species are reduced to the metallic form in a controlled fashion because of the organic structure directing reagent, preventing the formation of much larger Ir/IrO₂ nanoparticles like those in commercial IrO₂ catalysts. The organic structure directing agent plays an important role in dictating the morphology of the final Ir/IrOₓ material. During the synthesis, a solution is made of an iridium-based precursor in a first solvent. An organic structure directing template is added to the first solution. A second solution comprising a reducing agent is provided. The first and second solutions are mixed forming the wet iridium-based catalyst.

The wet iridium-based catalyst is then dried. Suitable drying temperatures include, but are not limited to 30° C. to 100° C., or 30° C. to 50° C. Suitable drying times include, but are not limited to, 20 min to 600 min, or 20 min to 600 min, 20 min to 300 min, or 20 min to 240 min, or 20 min to 120 min, or 30 min to 600 min, 30 min to 300 min, or 30 min to 240 min, or 30 to 120 min.

In some embodiments, the wet iridium-based catalyst with water, or an organic solvent, or combinations thereof, before drying.

The organic structure directing template includes multiple heteroatoms, such as oxygen, nitrogen, sulfur and/or phosphorus, which can coordinate to the Ir metal center during the heating process. Suitable organic structure directing templates include, but are not limited to, oleylamine, cysteamine, tetradecyltrimethylammonium bromide 2,2′-bipyridine, terpyridine, trioctylamine, tris(2-aminoethyl)amine, ethylenediamine, 3-aminopropane-1-thiol, glycine, ethanolamine, polyethylene imine, or combinations thereof.

The reducing agent is used to reduce the Ir³⁺ to its metallic form, which subsequently forms the Ir nanoparticles. Suitable reducing agents include, but are not limited to, sodium borohydride, hydrazine, sodium bis(2-methoxyethoxy)aluminium hydride, diisobutylaluminium hydride, lithium aluminium hydride, ascorbic acid, or combinations thereof.

### EXAMPLES

### Example 1: Synthesis of Ir-Oleylamine Catalyst

A sample of 400 mg IrCl₃ hydrate was mixed with 90 mL ethanol in a flask, which was subjected to sonication for 30 minutes to assist the dissolution of the solid. An aliquot of 1 mL oleylamine was added to the solution, upon which a brownish precipitate formed. The flask was heated to 70° C. in a water bath, after which a 50 mL ethanolic solution containing 600 mg of NaBH₄ was added slowly to the mixture. The flask was kept at this temperature for 20 minutes. The formed black precipitate was recovered by centrifugation, which was then washed by ethanol three times and water one time. A typical yield from the synthesis is ˜85% based on Ir.

### Example 2: Intrinsic Oxygen Evolution Reaction (OER) Activity Evaluation of Two Iridium-Based Catalysts

A commercial IrO₂ catalyst and the new Ir-oleylamine catalyst made in Example 1 were evaluated in a benchtop electrochemical testing unit. The catalyst ink was prepared by mixing the catalyst and Nafion® ionomer (5 wt % in alcohol) in a mixture of deionized water and ethyl alcohol. The mixture was finely dispersed using an ultrasonication bath. An aliquot of 10 uL of the prepared ink was drop-casted on a glassy carbon working electrode. After drying in air for 20 minutes, the electrode with the drop-casted catalyst was placed in an electrochemical testing cell, along with a counter electrode made of Pt sheet and an Ag/AgCl (4M KCl) reference electrode.

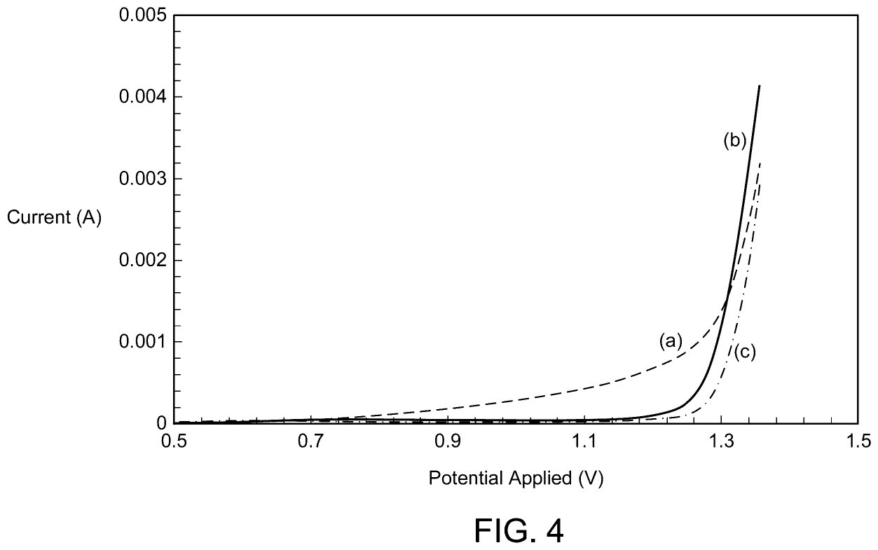

A linear sweep voltammetry (LSV) measurement in the range of 0.5 to 1.35 V (vs. Ag/AgCl) with a 10 mV/s rate was conducted, and the results for both samples are compiled in FIG. 4. In a LSV measurement, the current, which is a measure of oxygen evolution reaction rate, is measured when scanning the voltage applied to the working electrode, which is a measure of energy applied into the reaction. An ideal OER catalyst has as a high current at a low applied voltage, for example the catalyst can achieve 10 mA/cm² at an overpotential of 250 mA. As shown in FIG. 4a, the as synthesized Ir-oleylamine catalyst has better OER activity because it has a higher OER current at any applied cell voltage (vs. Ag/AgCl) in the measured range. The commercial IrO₂ is a less active catalyst because it exhibits the lowest OER current at any applied cell voltage (FIG. 4c). Another notable feature for the new Ir-based catalysts is the redox event occurring at 0.7-1.3 V applied voltage (vs. Ag/AgCl). This is believed to be due to the oxidation of Ir-related species, which is indicative of the as synthesized Ir-oleylamine catalyst being mainly Ir. This feature disappears once the Ir-oleylamine catalyst is electrochemically oxidized. Upon oxidation, the Ir-oleylamine catalyst also becomes more active than its as synthesized form because of the higher current density at 1.35 V (vs. Ag/AgCl) (FIG. 4b).

### Example 3: Water Electrolysis Performance Evaluation of Two Iridium-Based Catalysts

The water electrolysis performance of a commercial IrO₂ catalyst and the new Ir-oleylamine made in Example 1 were evaluated using a single water electrolysis cell at 80° C., atmospheric pressure.

A commercial IrO₂ catalyst-coated membrane and an Ir-oleylamine catalyst-coated membrane were prepared using a perfluorosulfonic acid polymer-based membrane with a thickness of 55 μm, a commercial Pt/C catalyst as the cathode coating layer on one side of the membrane for the hydrogen evolution reaction (HER), and the commercial IrO₂ catalyst (or the Ir-oleylamine nanonet catalyst) as the anode coating layer on the other side of the membrane for the OER, respectively. The Ir loading and Pt loading on the commercial IrO₂ catalyst-coated membrane were 0.9 mg/cm² and 0.15 mg/cm², respectively. The Ir loading and Pt loading on the Ir-oleylamine catalyst-coated membrane was 0.21 mg/cm² and 0.18 mg/cm², respectively. The catalyst-coated membrane was sandwiched between two Pt-coated Ti-felt as the anode and cathode porous transport layers to form the catalyst-coated membrane electrode assembly. Then, the testing cell was installed using the catalyst-coated membrane electrode assembly.

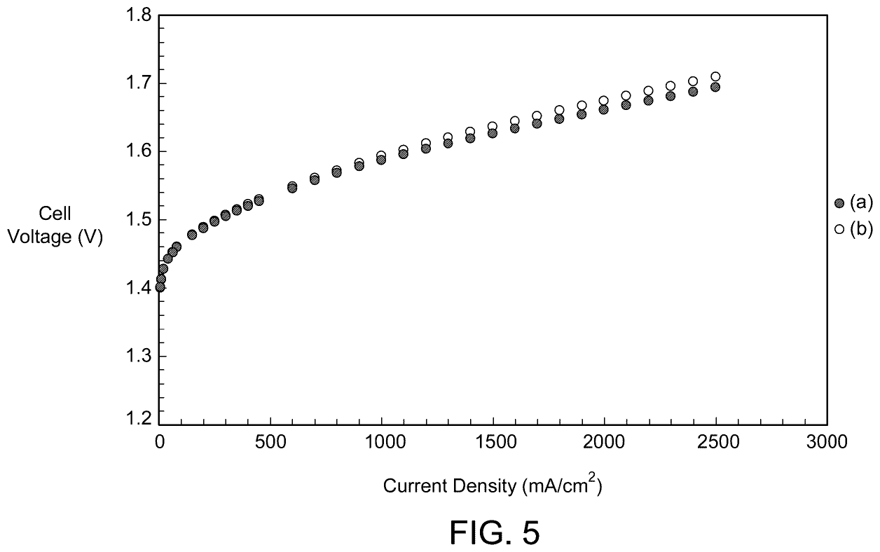

A proton exchange membrane (PEM) water electrolysis test station (Scribner 600 electrolyzer test system) was used to evaluate the water electrolysis performance of the commercial IrO₂ catalyst-coated membrane electrode assembly, the Ir-oleylamine catalyst-coated membrane electrode assembly in a single electrolyzer cell with an active membrane area of 5 cm². Porous transport layers (PTLs) and compression factors, defined as ratio between sealing gasket thickness and PTL thickness, were identical between these assemblies. The test station included an integrated power supply, a potentiostat, an impedance analyzer for electrochemical impedance spectroscopy (EIS) and high-frequency resistance (HFR), and real-time sensors for product flow rate and cross-over monitoring. The testing was conducted at 80° C. and at 15 psig pressure. Ultrapure water was supplied to the anode of the cell with a flow rate of 100 mL/min. The polarization curve was prepared (each datapoint end of 1 min hold) as shown in FIG. 5.

It can be seen from FIG. 5 that the Ir-oleylamine catalyst-coated membrane electrode assembly with very low Ir loading of 0.21 mg/cm² showed water electrolysis performance (FIG. 5a) comparable to the commercial IrO₂ catalyst-coated membrane electrode assembly with higher Ir loading of 0.9 mg/cm² (FIG. 5b) as evident from the comparable current density at equal voltages.

### SPECIFIC EMBODIMENTS

While the following is described in conjunction with specific embodiments, it will be understood that this description is intended to illustrate and not limit the scope of the preceding description and the appended claims.

A first embodiment of the invention is an iridium-based catalyst comprising a catalytic material comprising particles comprising iridium or a mixture of iridium and iridium oxide and having a BET surface area of 30 m²/g or more and a pore volume of 0.10 cc/g or more, the particles having a size in a range of 50 nm to 1 μm, and wherein the particles comprise an interconnected network of nanoparticles having a size in a range of 2 nm to 15 nm. An embodiment of the invention is one, any or all of prior embodiments in this paragraph up through the first embodiment in this paragraph wherein the particles have the size in a range of 50 nm to 500 nm. An embodiment of the invention is one, any or all of prior embodiments in this paragraph up through the first embodiment in this paragraph wherein the particles have the size in a range of 100 nm to 500 nm. An embodiment of the invention is one, any or all of prior embodiments in this paragraph up through the first embodiment in this paragraph wherein the particles have the size in a range of 200 nm to 500 nm. An embodiment of the invention is one, any or all of prior embodiments in this paragraph up through the first embodiment in this paragraph wherein the nanoparticles have the size in the range of 2 nm to 10 nm. An embodiment of the invention is one, any or all of prior embodiments in this paragraph up through the first embodiment in this paragraph wherein the nanoparticles have the size in the range of 2 nm to 5 nm. An embodiment of the invention is one, any or all of prior embodiments in this paragraph up through the first embodiment in this paragraph wherein the pore volume is 0.20 cc/g or more. An embodiment of the invention is one, any or all of prior embodiments in this paragraph up through the first embodiment in this paragraph wherein the pore volume is in a range of 0.10 cc/g to 0.70 cc/g. An embodiment of the invention is one, any or all of prior embodiments in this paragraph up through the first embodiment in this paragraph wherein the pore volume is in a range of 0.10 cc/g to 0.40 cc/g. An embodiment of the invention is one, any or all of prior embodiments in this paragraph up through the first embodiment in this paragraph wherein the catalyst particles have a size in a range of 200 nm to 500 nm, the nanoparticles have a size in a range of 2 nm to 5 nm, and the pore volume is in a range of 0.10 cc/g to 0.40 cc/g.

A second embodiment of the invention is a method of making an iridium-based catalyst comprising providing a first solution comprising an iridium-based precursor in a first solvent; adding an organic structure directing template to the first solution; providing a second solution comprising a reducing agent in a second solvent; mixing the first solution with the second solution forming a wet iridium-based catalyst; and drying the wet iridium-based catalyst forming the iridium-based catalyst comprising iridium or a mixture of iridium and iridium oxide particles having a BET surface area of 30 m²/g or more and a pore volume of 0.10 cc/g or more, the particles having a size in a range of 50 nm to 1 μm, and wherein the particles comprise an interconnected network of nanoparticles having a size in a range of 2 nm to 15 nm. An embodiment of the invention is one, any or all of prior embodiments in this paragraph up through the second embodiment in this paragraph wherein the organic structure directing template comprises oleylamine, cysteamine, tetradecyltrimethylammonium bromide, 2,2′-bipyridine, terpyridine, trioctylamine, tris(2-aminoethyl)amine, ethylenediamine, 3-aminopropane-1-thiol, glycine, ethanolamine, polyethylene imine, or combinations thereof. An embodiment of the invention is one, any or all of prior embodiments in this paragraph up through the second embodiment in this paragraph wherein the reducing agent comprises sodium borohydride, hydrazine, sodium bis(2-methoxyethoxy)aluminium hydride, diisobutylaluminium hydride, lithium aluminium hydride, ascorbic acid, or combinations thereof. An embodiment of the invention is one, any or all of prior embodiments in this paragraph up through the second embodiment in this paragraph wherein the wet iridium-based catalyst is dried at a temperature in a range of 30° C. to 100° C. An embodiment of the invention is one, any or all of prior embodiments in this paragraph up through the second embodiment in this paragraph wherein the wet iridium-based catalyst is dried at a temperature in a range of 30° C. to 50° C. An embodiment of the invention is one, any or all of prior embodiments in this paragraph up through the second embodiment in this paragraph further comprising washing the wet iridium-based catalyst with water, or an organic solvent, or combinations thereof, before drying. An embodiment of the invention is one, any or all of prior embodiments in this paragraph up through the second embodiment in this paragraph wherein the particles have the size in the range of 50 nm to 500 nm. An embodiment of the invention is one, any or all of prior embodiments in this paragraph up through the second embodiment in this paragraph wherein the nanoparticles have the size in range of 2 nm to 10 nm. An embodiment of the invention is one, any or all of prior embodiments in this paragraph up through the second embodiment in this paragraph wherein the particles have the size in the range of 50 nm to 500 nm, the nanoparticles have the size in the range of 2 nm to 5 nm, and the pore volume is in the range of 0.10 cc/g to 0.40 cc/g. An embodiment of the invention is one, any or all of prior embodiments in this paragraph up through the second embodiment in this paragraph wherein the particles have the size in a range of 200 nm to 500 nm, the nanoparticles have the size in the range of 2 nm to 5 nm, and the pore volume is in a range of 0.10 cc/g to 0.40 cc/g.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An iridium-based catalyst comprising:
a catalytic material comprising particles comprising iridium or a mixture of iridium and iridium oxide and having a BET surface area of 30 m²/g or more and a pore volume of 0.10 cc/g or more, the particles having a size in a range of 50 nm to 1 μm, and wherein the particles comprise an interconnected network of nanoparticles having a size in a range of 2 nm to 15 nm.

2. The catalyst of claim 1 wherein the particles have the size in a range of 50 nm to 500 nm.

3. The catalyst of claim 1 wherein the particles have the size in a range of 100 nm to 500 nm.

4. The catalyst of claim 1 wherein the particles have the size in a range of 200 nm to 500 nm.

5. The catalyst of claim 1 wherein the nanoparticles have the size in the range of 2 nm to 10 nm.

6. The catalyst of claim 1 wherein the nanoparticles have the size in the range of 2 nm to 5 nm.

7. The catalyst of claim 1 wherein the pore volume is 0.20 cc/g or more.

8. The catalyst of claim 1 wherein the pore volume is in a range of 0.10 cc/g to 0.70 cc/g.

9. The catalyst of claim 1 wherein the pore volume is in a range of 0.10 cc/g to 0.40 cc/g.

10. The catalyst of claim 1 wherein the catalyst particles have a size in a range of 200 nm to 500 nm, the nanoparticles have a size in a range of 2 nm to 5 nm, and the pore volume is in a range of 0.10 cc/g to 0.40 cc/g.

11. A method of making an iridium-based catalyst comprising:
providing a first solution comprising an iridium-based precursor in a first solvent;
adding an organic structure directing template to the first solution;
providing a second solution comprising a reducing agent in a second solvent;
mixing the first solution with the second solution forming a wet iridium-based catalyst; and
drying the wet iridium-based catalyst forming the iridium-based catalyst comprising iridium or a mixture of iridium and iridium oxide particles having a BET surface area of 30 m²/g or more and a pore volume of 0.10 cc/g or more, the particles having a size in a range of 50 nm to 1 μm, and wherein the particles comprise an interconnected network of nanoparticles having a size in a range of 2 nm to 15 nm.

12. The method of claim 11 wherein the organic structure directing template comprises oleylamine, cysteamine, tetradecyltrimethylammonium bromide, 2,2′-bipyridine, terpyridine, trioctylamine, tris(2-aminoethyl)amine, ethylenediamine, 3-aminopropane-1-thiol, glycine, ethanolamine, polyethylene imine, or combinations thereof.

13. The method of claim 11 wherein the reducing agent comprises sodium borohydride, hydrazine, sodium bis(2-methoxyethoxy)aluminium hydride, diisobutylaluminium hydride, lithium aluminium hydride, ascorbic acid, or combinations thereof.

14. The method of claim 11 wherein the wet iridium-based catalyst is dried at a temperature in a range of 30° C. to 100° C.

15. The method of claim 11 wherein the wet iridium-based catalyst is dried at a temperature in a range of 30° C. to 50° C.

16. The method of claim 11 further comprising:
washing the wet iridium-based catalyst with water, or an organic solvent, or combinations thereof, before drying.

17. The method of claim 11 wherein the particles have the size in the range of 50 nm to 500 nm.

18. The method of claim 11 wherein the nanoparticles have the size in a range of 2 nm to 10 nm.

19. The method of claim 11 wherein the particles have the size in the range of 50 nm to 500 nm, the nanoparticles have the size in the range of 2 nm to 5 nm, and the pore volume is in the range of 0.10 cc/g to 0.40 cc/g.

20. The method of claim 11 wherein the particles have the size in a range of 200 nm to 500 nm, the nanoparticles have the size in the range of 2 nm to 5 nm, and the pore volume is in a range of 0.10 cc/g to 0.40 cc/g.
